(19) United States
(12) Patent Application Publication
(10) Pub. No.: US 2017/0293892 A1
(43) Pub. Date: Oct. 12, 2017

(54) RELEASING CONTENT INTERACTION STATISTICS WHILE PRESERVING PRIVACY

(71) Applicant: Linkedln Corporation, Mountain View, CA (US)

(72) Inventor: Krishnaram Kenthapadi, Sunnyvale, CA (US)

(21) Appl. No.: 15/096,964

(22) Filed: Apr. 12, 2016

(51) Int. Cl. G06Q 10/10; G06Q 50/00; G06F 21/10; H04L 29/06; H04L 29/08

(52) U.S. Cl. CPC G06Q 10/1053; H04L 67/42; H04L 67/22; G06F 21/10; G06Q 50/01

(57) ABSTRACT

Aspects of the present disclosure relate to releasing content interaction statistics while preserving privacy. A server receives a request for statistics about user interaction with content items. The server accesses, in response to the request for statistics, a user-content interaction log that stores data representing interactions of users with content items. The server generates, using the user-content interaction log, a user-content interaction data set grouping users according to the user features and grouping content items according to the content features. The server preprocesses the user-content interaction data set to limit activity of each user with each content item in the user-content interaction data set. The server computes statistics, using the preprocessed user-content interaction data set, regarding interactions of users having a specified user feature with content items having a specified content feature. The server generates output statistics by adding a random noise variable to the computed statistics.

### TECHNICAL FIELD

The subject matter disclosed herein relates to data processing and social networking. In particular, example embodiments may relate to releasing content interaction statistics while preserving privacy.

### BACKGROUND

Social networking services collect much data about their users and the content stored within the social networking services. In some cases, a social networking service may wish to share its data with an external researcher, for example, to allow the researcher to study, in a general sense, how users interact with content items. However, the social networking service may wish to avoid compromising its user's privacy, to comply with legal requirements and maintain its goodwill and reputation.

### SUMMARY

In one aspect, the disclosed subject matter can be embodied in a method. The method includes receiving, at a server, a request for statistics about user interaction with content items, wherein users are grouped according to user features, and wherein the content items are grouped according to content features. The method includes accessing, in response to the request for statistics, a user-content interaction log, the user-content interaction log storing data representing interactions of a plurality of users with a plurality of content items. The method includes generating, using the user-content interaction log, a user-content interaction data set grouping users according to the user features and grouping content items according to the content features specified in the request for statistics. The method includes preprocessing the user-content interaction data set to limit activity of each user with each content item in the user-content interaction data set. The method includes computing statistics, using the preprocessed user-content interaction data set, regarding interactions of users having a specified user feature with content items having a specified content feature. The method includes generating output statistics by adding a random noise variable to the computed statistics. The method includes providing a representation of the generated output statistics.

In one aspect, the disclosed subject matter can be embodied in a non-transitory computer-readable medium including instructions. The instructions include code for receiving a request for statistics about user interaction with content items, wherein users are grouped according to user features, and wherein the content items are grouped according to content features. The instructions include code for accessing, in response to the request for statistics, a user-content interaction log, the user-content interaction log storing data representing interactions of a plurality of users with a plurality of content items. The instructions include code for generating, using the user-content interaction log, a user-content interaction data set grouping users according to the user features and grouping content items according to the content features specified in the request for statistics. The instructions include code for preprocessing the user-content interaction data set to limit activity of each user with each content item in the user-content interaction data set. The instructions include code for computing statistics, using the preprocessed user-content interaction data set, regarding interactions of users having a specified user feature with content items having a specified content feature. The instructions include code for generating output statistics by adding a random noise variable to the computed statistics. The instructions include code for providing a representation of the generated output statistics.

In one aspect, the disclosed subject matter can be embodied in a system. The system includes one or more processors and a memory. The memory stores instructions for execution by the one or more processors. The instructions include code for receiving a request for statistics about user interaction with content items, wherein users are grouped according to user features, and wherein the content items are grouped according to content features. The instructions include code for accessing, in response to the request for statistics, a user-content interaction log, the user-content interaction log storing data representing interactions of a plurality of users with a plurality of content items. The instructions include code for generating, using the user-content interaction log, a user-content interaction data set grouping users according to the user features and grouping content items according to the content features specified in the request for statistics. The instructions include code for preprocessing the user-content interaction data set to limit activity of each user with each content item in the user-content interaction data set. The instructions include code for computing statistics, using the preprocessed user-content interaction data set, regarding interactions of users having a specified user feature with content items having a specified content feature. The instructions include code for generating output statistics by adding a random noise variable to the computed statistics. The instructions include code for providing a representation of the generated output statistics.

### BRIEF DESCRIPTION OF THE DRAWINGS

Various ones of the appended drawings merely illustrate example embodiments of the present inventive subject matter and cannot be considered as limiting its scope.

FIG. 1 is a diagram of an example system in which a social networking service may be implemented.

FIG. 2 is a block diagram of an example of the data repository of FIG. 1.

FIG. 3 is a block diagram of an example of the server of FIG. 1.

FIG. 4 is a data flow diagram for releasing content interaction statistics while preserving privacy.

FIG. 5 is a flowchart illustrating a method for releasing content interaction statistics while preserving privacy.

FIG. 6 conceptually illustrates an example electronic system with which some implementations of the subject technology can be implemented.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

As noted above, social networking services collect much data about their users and the content stored within them. In some cases, a social networking service may wish to share its data with an external researcher, for example, to allow the researcher to study, in a general sense, how users interact with content items. However, the social networking service may wish to avoid compromising its user's privacy, to comply with legal requirements and maintain its goodwill and reputation. As the foregoing illustrates, a new approach for releasing content interaction statistics while preserving privacy may be desirable.

The subject technology provides a systematic framework for releasing aggregate user-content interaction data statistics, in a provably privacy-preserving manner. Consequently, the subject technology enables, among other things, scientific research and analysis over the released dataset to answer questions such as “What is the likelihood that a user of a social networking service for professionals will apply to a job, advertised as a content item in the social networking service, in a geographic location different from where he/she currently resides?”, while ensuring that no additional knowledge about any specific user is revealed from the data release. Some aspects of the subject technology achieve this balance by adding random noise, drawn from appropriate distributions, to the aggregate statistics counts.

Aspects of the subject technology relate to, among other things, techniques to define grouping predicates and aggregate statistics of interest depending on the application, techniques to perform preprocessing to limit each user's activity (and hence influence) on the dataset, techniques to add random noise to aggregated user-content interaction data statistics (such as job impressions, job views, jobs saved, job applications, where a job is a content item in the social networking service), defined over appropriate grouping predicates, and techniques to perform post-processing to ensure consistency (which is potentially affected by the addition of noise).

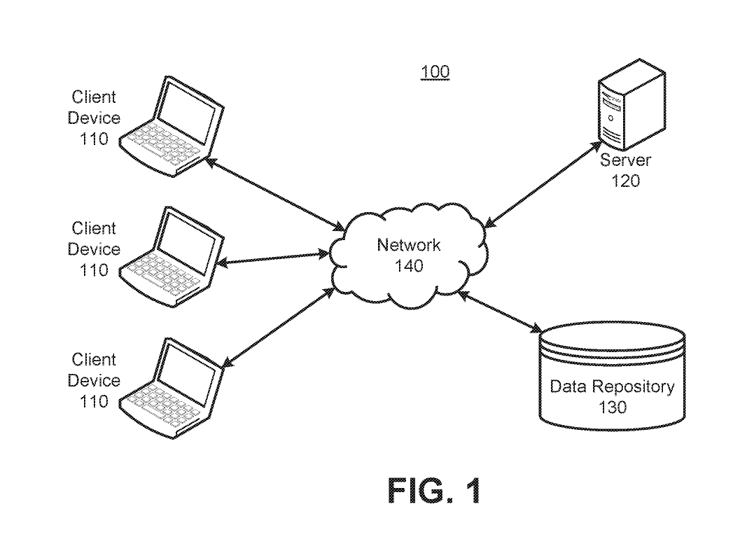

FIG. 1 is a diagram of an example system 100 in which a social networking service may be implemented. As shown, the system 100 includes client device(s) 110, a server 120, and a data repository 130 connected to one another via a network 140. The network 140 may include one or more of the Internet, an intranet, a local area network, a wide area network (WAN), a cellular network, a WiFi network, a virtual private network (VPN), a public network, a wired network, a wireless network, etc. Aspects of the subject technology are implemented at the server 120, which accesses data from the data repository 130 in response to a request from the client device 110.

The client device(s) 110 may include one or more of a laptop computer, a desktop computer, a mobile phone, a tablet computer, a personal digital assistant (PDA), a digital music player, etc. The client device 110 may include an application (or multiple applications), such as a web browser or a special purpose application, for communicating with the server 120 and the data repository 130. Using the application, a user of the client device 110 may access content items within the social networking service. A user of the client device 110 may also request statistics about user interaction with content items and receive a representation of statistics generated, using the techniques described herein, in response to the request. While three client devices 110 are illustrated in FIG. 1, the subject technology may be implemented with any number of client device(s) 110.

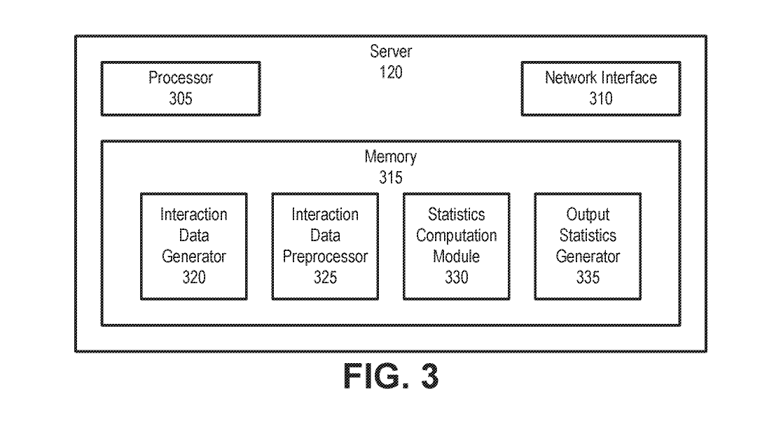

The server 120 stores data or instructions. The server 120 is programmed to generate user-content interaction data and statistics in response to a request from the client device 110. More details of the operation of the server 120 are provided in conjunction with FIG. 3.

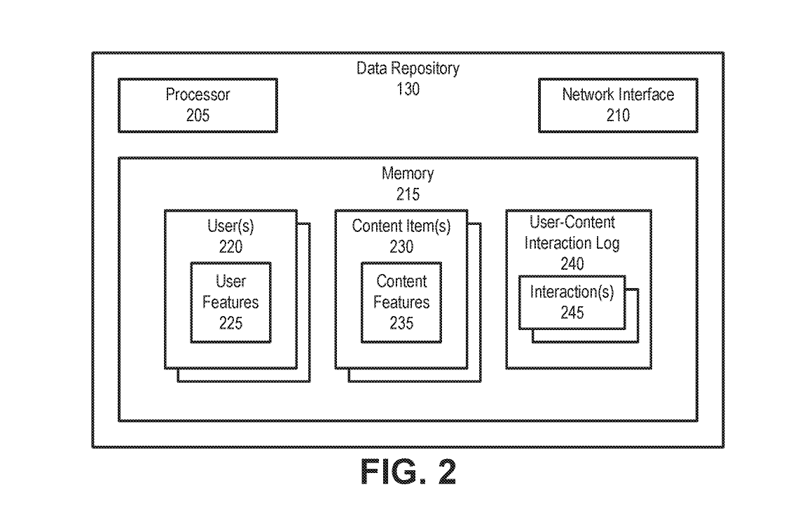

The data repository 130 stores information about users and content, and interactions of users with content, in the social networking service. The data in the data repository 130 is accessible to the server 120 of the social networking service. However, limited access or no access to the data repository 130 may be provided to machines that are not associated with the social networking service. More details of the operation of the data repository 130 are provided in conjunction with FIG. 2.

In the implementation of FIG. 1, the system 100 includes a single data repository 130 and a single server 120. However, the subject technology may be implemented with multiple data repositories or multiple servers. Furthermore, as shown in FIG. 1, a single network 140 connects the client device(s) 110, the server 120, and the data repository 130. However, the subject technology may be implemented using multiple networks to connect the machines. Additionally, while the server 120 and the data repository 130 are illustrated as being distinct machines, in some examples, a single machine functions as both the server 120 and the data repository 130.

FIG. 2 is a block diagram of an example of the data repository 130 of FIG. 1. As shown, the server 120 includes a processor 205, a network interface 210, and a memory 215. The processor 205 executes machine instructions, which may be stored in the memory 215. While a single processor 205 is illustrated, the server 120 may include multiple processors arranged into multiple processing units (e.g., central processing unit (CPU), graphics processing unit (GPU), etc.). The processor 205 includes one or more processors. The network interface 210 allows the server 120 to send and receive data via the network 140. The network interface 210 includes one or more network interface cards (NICs). The memory 215 stores data or instructions. As shown, the memory 215 includes information about user(s) 220, information about content items 230, and a user-content interaction log 240.

The data repository 130 is illustrated in FIG. 2 as including the processor 205. However, in some implementations, the data repository lacks the processor 205. Instead, the data repository is attached to the server 120, which accesses the memory 215 of the data repository 130 via a wired, wireless or network connection.

The information about user(s) 220 stores information about users of the social networking service, such as a user's name, email, telephone, home address, work address, and other information the user provides to the social networking service. Each user 220 is associated with user features 225. The user features 225 include, for example, a job title of the user, an industry of the user, a profession of the user, a professional level of seniority of the user, a geographic location of the user, an employer of the user, an academic degree of the user, or an educational institution of the user, and any other features of users stored by the social networking service in the data repository 130. The geographic location of the user may correspond to one or more of a home location of the user and a work location of the user. In some cases, multiple geographic locations are associated with a user. For example, a user who resides in New York City may have grown up in Philadelphia and attended college in Los Angeles. Such a user may be associated with one or more of the geographic locations New York City, Philadelphia, and Los Angeles. The geographic location of the user may be a specific location (e.g., a street address) or a general location for example, a city, a state, or a metropolitan area.

The information about content item(s) 230 stores information about content items posted in the social networking service. The content item(s) 230 may include text posts, photographs, videos, or job postings within the social networking service. A content item 230 is associated with content features 235. The content features 235 may include a content type (e.g., video) and a content genre (e.g., music, self-help, legal etc.). In some examples, the content item 230 is a job posting, and the content features 235 include one or more of an industry of the job, a profession associated with the job, a professional level of seniority associated with the job, a proposed salary for the job, and a geographic location of the job.

The user-content interaction log 240 stores information about interaction(s) 245 between the user(s) 220 and the content item(s) 230. The interaction(s) 245 include, for example, viewing a content item 230 in a feed, selecting the content item 230, playing the content item 230, taking a viral action (e.g., like, comment, or share) or any other action on the content item 230. In some cases, where the content item(s) 230 are job postings, the interactions 245 include one or more of viewing a job posting within a listing of job postings, selecting the job posting from within the listing of job postings, applying for the job posting, and indicating acceptance of a position associated with the job posting.

As used herein, the phrase “viral action” encompasses its plain and ordinary meaning. A viral action may include, among other things, an indication for preference on a content item, a comment on the content item, a share of the content item, or any other action, related to the content item, that is shown to an additional user of the social networking service. A viral action may include any action that causes the content item to be circulated to users of the social networking service different from the user taking the action, for example, that user's contacts or “friends” in the social networking service. It should be noted that virality is defined in the Oxford Dictionary (2015) as “the tendency of an image, video, or piece of information to be circulated rapidly and widely from one Internet user to another.”

FIG. 3 is a block diagram of an example of the server 120 of FIG. 1. As shown, the server 120 includes a processor 305, a network interface 310, and a memory 315. The processor 305 executes machine instructions, which may be stored in the memory 315. While a single processor 305 is illustrated, the server 120 may include multiple processors arranged into multiple processing units (e.g., central processing unit (CPU), graphics processing unit (GPU), etc.). The processor 305 includes one or more processors. The network interface 310 allows the server 120 to send and receive data via the network 140. The network interface 310 includes one or more network interface cards (NICs). The memory 315 stores data or instructions. As shown, the memory 315 includes an interaction data generator 320, an interaction data preprocessor 325, a statistics computation module 330, and an output statistics generator 335.

The interaction data generator 320 is configured to receive, from a client device 110, a request for statistics about user interaction with content items. In the request, users are grouped according to user features and content items are grouped according to content features. For example, a request may inquire about the proportion of users in each state in the United States between ages 20 and 30 who have played at least one music video or at least one instructional video, via the social networking service, in the month of February 2016. The interaction data generator 320 is configured to access, in response to the request for statistics, the user-content interaction log 240, which stores data representing interactions 245 of multiple users with multiple content items. The interaction data generator 320 is configured to generate, using the user-content interaction log 240, a user-content interaction data set grouping users according to the user features (e.g., grouping users age 20-30 by state in the United States) and grouping content items according to the content features (e.g., music video or instructional video) specified in the request for statistics.

The interaction data preprocessor 325 is configured to preprocess the user-content interaction data set to limit activity of each user with each content item in the user-content interaction data set (e.g., to avoid double-counting users who watched a music video two or more times). The interaction data preprocessor 325 removes, from the user-content interaction data set, any user information that is not used for statistical computation, for example, first and last names of users are removed. Other identifying information (e.g., geographic location information) is obfuscated to remove street addresses but to include low-resolution geographic data (e.g., city or metropolitan area). Telephone numbers are obfuscated to include a country code and an area code, but to remove identifying digits. In some cases, data for smaller communities (e.g., geographic communities, professional communities, and the like) is obfuscated further. For example, thousands of residents of New York City may have a mobile telephone number in the 617 (Boston) area code. However, only one resident of a small village in North Carolina may have such a telephone number. Thus, information identifying a user as having a 617 number in New York City may be used for statistical analysis, but information identifying a user as having a 617 number in the North Carolina village is not used, as such data may lead to personal identification of the user. After preprocessing the user-content interaction data set, each and every user whose data is in the preprocessed user-content interaction data set cannot be identified using the information in the preprocessed user-content interaction data set. In some cases, after preprocessing the user-content interaction data set, only the data needed for computing predicates is provided. Thus, each user may remain anonymous and may not be identified using the data provided to the client device 110 of the requestor.

The statistics computation module 330 is configured to compute statistics, using the preprocessed user-content interaction data set, regarding interactions of users having a specified user feature (e.g., users age 20-30 in California) with content items having a specified content feature (e.g., music videos). In some examples, the computed statistics include a proportion of users having specified user features who interacted with one or more content items having specified content item features according to specified interactions (e.g., playing a video).

The output statistics generator 335 is configured to generate output statistics by adding a random noise variable to the computed statistics. The random noise variable may be implemented, for example, using a computerized random number generator. The output statistics generator 335 is configured to provide, to the client device 110 that transmitted the request for statistics, a representation of the generated output statistics. In some cases, the output statistics generator 335 is configured to post-process the generated output statistics to ensure consistency with the user-content interaction data set (e.g., no proportions less than 0 or greater than 1). In some cases, the client device 110 that transmitted the request for statistics specifies a format in which the statistics are to be provided to the client device 110. The output statistics generator 335 transmits, to the client device 110, the representation of the generated output statistics using the format specified in the received request for statistics.

As used herein, the term “configured” encompasses its plain and ordinary meaning. A module (e.g., interaction data generator 320, interaction data preprocessor 325, statistics computation module 330, or output statistics generator 335) may be configured to carry out operation(s) by storing code for the operation(s) in memory (e.g., memory 215). Processing hardware (e.g., processor 205) may carry out the operations by accessing the appropriate locations in the memory. Alternatively, the module may be configured to carry out the operation(s) by having the operation(s) hard-wired in the processor.

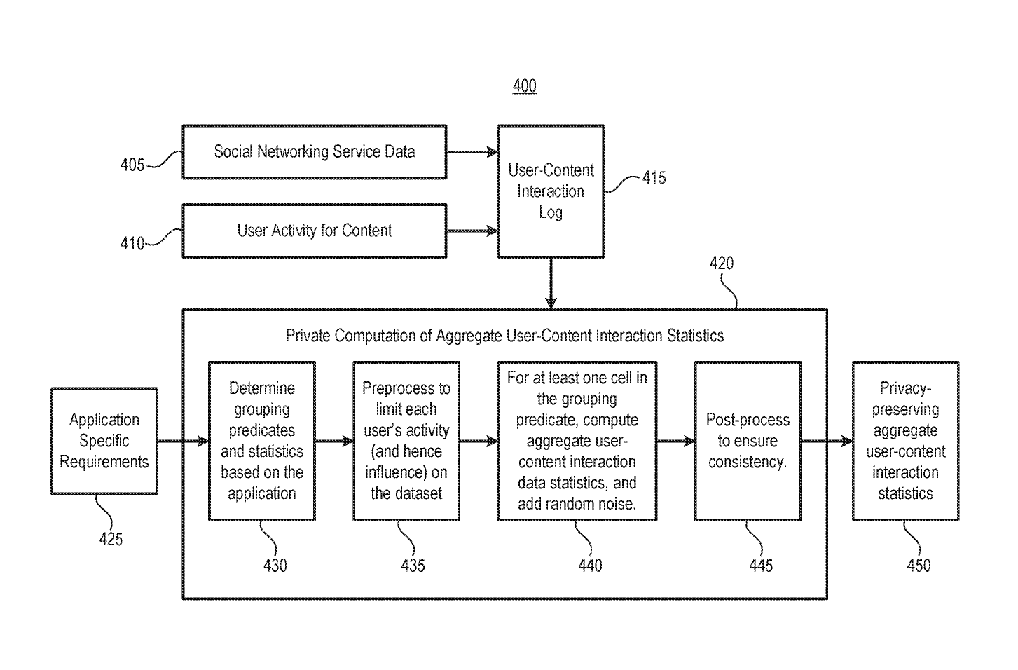

FIG. 4 is a data flow diagram illustrating a data flow 400 for releasing content interaction statistics while preserving privacy. As shown in the data flow 400, social networking service data 405 and user activity for content 410 is provided to the user-content interaction log 415 (which may correspond to the user-content interaction log 240 of the data repository 130). The user-content interaction log 415 is accessible to a private computation of aggregate user-content interaction statistics module 420. According to some implementations, the module 420 resides at the server 120.

The private computation of aggregate user-content interaction statistics module 420 is configured to receive, as input, application-specific requirements 425 (e.g., from a client device 110). The private computation of aggregate user-content interaction statistics module 420 includes a component 430 configured to determine grouping predicates and statistics based on the application. The component 430 may be implemented within the interaction data generator 320 of FIG. 3. The component 430 is configured to determine grouping predicates based on the application-specific requirements 425. For example, for the application of inferring the likelihood of users of a professional networking service applying for a job (which is an example of a content item) in a geographic location different from their current geographic location, the grouping can be performed with respect to <userZip, jobZip, jobindustry, jobFunction, jobSeniority>. In other words, the module 420 is configured to compute aggregate statistics for each possible value of this tuple. Equivalently, aspects of the subject technology can be viewed as a computing histogram with each cell being a possible value of <userZip, jobZip, jobIndustry, jobFunction, jobSeniority>. In this scenario, the aggregate statistics include, for example, a number of job impressions, a number of job views, a number of job applications, etc.

The module 420 also includes a component 435 to preprocess to limit each user's activity (and hence influence) on the dataset. The component 435 may be implemented within the interaction data preprocessor 325 of FIG. 3. The component 435 is configured to limit each user's activity by keeping only first d0 content item impressions, d1 content item views, d2 content item applications, d3 saved content items, etc., where d0, d1, d2, and d3 are predetermined positive integer constants. The values of d0 d1, d2, and d3 are selected such that any one user should not have excessive influence on the aggregate statistics computed. In some cases, d0, d1, d2, and d3 are selected based on the desired level of privacy. Smaller values of these parameters correspond to more privacy since the influence of any one user is reduced. The preprocessing of the component 435 limits the influence of any one user on the value of the function output, and hence the output is not likely to differ significantly whether or not this user is part of the dataset.

The module 420 also includes a component 440 which is configured to, for at least one cell in the grouping predicate (or each cell in the grouping predicate), compute aggregate user-content interaction data, and add random noise. As used herein, the term “cell” encompasses its plain and ordinary meaning. In some cases, a cell is defined as one grouping unit in the block of statistics sought. For example, if a statistician is studying to and from which states in the United States people are moving; one cell includes people who moved from the State of California to the State of Nevada. If a statistician is studying the number of people who watched videos of cats in the last month, as stratified by age (in decades, e.g., 20-29, 30-39, 40-49 etc.) and education level (e.g., high school graduates, college graduates, advanced degree holders, etc.); one cell includes 20-29 year olds who are college graduates.

The component 440 may be implemented within the statistics computation module 330 or the output statistics generator 335 of FIG. 3. The component 440 is configured to compute different types of aggregated statistics (such as a number of content item impressions, content item views, content items saved, content item applications) over the data after preprocessing, and then to add noise drawn from appropriate distributions to each type of aggregate statistics, to satisfy “differential privacy” guarantees. The noise addition helps to ensure that no additional knowledge about any specific user is revealed from the published dataset.

As used herein, the phrase “differential privacy” encompasses its plain and ordinary meaning. In some examples, “differential privacy” refers to techniques to maximize the accuracy of queries from statistical data repositories (e.g., databases) while minimizing the chances of identifying the records of the statistical data repositories. In some examples, “differential privacy” measures the increased risk to a user's privacy by being part of a statistical data repository. Upon seeing a published dataset, an attacker should gain very little additional knowledge about any specific user. In some examples, this is achieved by adding noise (e.g., from Laplace or Gaussian distribution) to the true answer of a statistical query function (e.g., number of job views in a professional social networking service), and releasing the noisy answer. The amount of noise to be added depends on how “sensitive” the query function is to the actions of any one member. According to some aspects, the sensitivity of the query function is computed as the maximum possible difference in the function value upon adding or removing one user from the dataset. It can either be analytically estimated, or empirically calculated from the dataset.

In accordance with some aspects of the subject technology, the requested output is treated as a histogram query: for the example application scenario of users applying to jobs posted in a professional social networking service, the server (e.g., server 120) computes a number of job impressions, job views, and job applications for each possible histogram cell, q=<userZip, jobZip, johnIndustry, jobFunction, jobSeniority>. A benefit of viewing output as a histogram query is that the total “sensitivity” of this query to any user's actions is bounded (e.g., by excluding any one user, the total number of job impressions can change by at most d0; the total number of job views can change by at most d1; the total number of job applications can change by at most d2; the total number of saved jobs can change by at most d3; etc.), and hence aspects of the subject technology may include adding only a small amount of noise that is independent of the dimension (the number of possible histogram cells).

One example of a noisy histogram counts algorithm, which may be implemented in conjunction with aspects of the subject technology, is provided below.

### Noisy Histogram Counts Algorithm

For each possible histogram cell, q, compute:
1. noisy #job-impressions i′(q)=#job-impressions(q)+Laplace(b0)
2. noisy #job-views v′(q)=#job-views(q)+Laplace(b1)
3. noisy #job-applications a′(q)=#job-applications(q)+Laplace(b2)
4. noisy #saved jobs s′(q)=#saved jobs(q)+Laplace(b3)

In the noisy histogram counts algorithm provided above, b0, b1, b2, and b3 are parameters of the Laplace distribution. The Laplace distribution parameters and the activity parameters (d0, d1, d2, and d3) determine the extent of privacy achieved. The larger the Laplace distribution parameters, the larger the amount of noise added, and hence greater the privacy achieved. The larger the activity numbers, the more the influence of any one user, and hence lower the privacy achieved.

In alternative embodiments, the noise random variable could be drawn from a different distribution (such as Gaussian distribution with zero mean), and could be determined based on a different privacy definition or requirement.

The module 420 also includes a component 445 to post-process the dataset to ensure consistency. The component 445 may be implemented within the output statistics generator 335 of FIG. 3. The component 445 is configured to perform post-processing to enhance the usability and interpretability of the published (e.g., to the client device 110) dataset. In some examples, the post-processing includes rounding fractional values to integers, as the addition of random noise can result in fractional values that do not make sense. For example, the post-processing may determine that the output should indicate that 3 people, not 2.7 people, from Oklahoma City, Okla. applied for software development jobs in San Francisco, Calif.). The component 445 is also configured to ensure significance and consistency of the output data. For example, the addition of noise might make it appear that the number of job applications for software development jobs in San Francisco from Oklahoma City exceeds the number of job views for the same parameters. The component 445, in some implementations, ensures that this is corrected such that the number of job views is greater than or equal to the number of job applications.

In some cases, the subject technology is implemented without the component 445, as the component 445 has no effect on user privacy. If the component 445 is not implemented, the output of the module 420, the privacy-preserving aggregate user-content interaction statistics 450, would be provided by the component 440. However, if the component 445 is implemented, the statistics 450 are provided by the component 445.

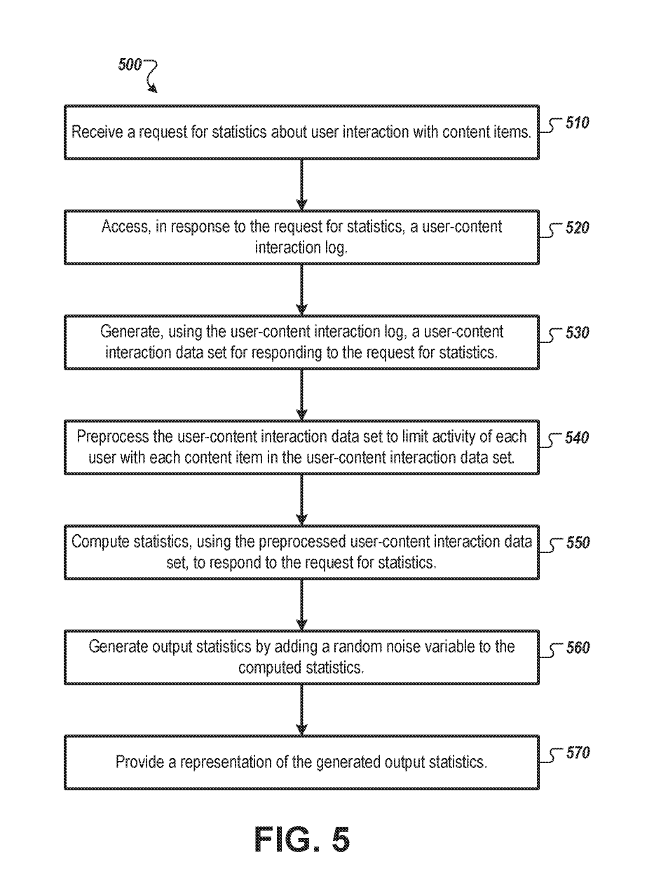

FIG. 5 is a flowchart illustrating a method 500 for releasing content interaction statistics while preserving privacy. The method 500 may be implemented at the server 120 or at the module 420 (which, in some cases, resides on the server 120).

The method 500 begins at step 510, where the server 120 receives a request for statistics (e.g., application-specific requirements 425) about user interaction with content items. In some examples, the request specifies the desired statistics and a desired format for the output. In the request, users are grouped according to user features and content items are grouped according to content features.

At step 520, the server 120 accesses, in response to the request for statistics, a user-content interaction log (e.g., user-content interaction log 240 or 415). The user-content interaction log stores data representing interactions of multiple users with multiple content items.

At step 530, the server 120 generates, using the user-content interaction log, a user-content interaction data set for responding to the request for statistics. The user-content interaction data set groups users according to the user features and groups content items according to the content features specified in the request for statistics.

At step 540, the server 120 preprocesses the user-content interaction data set to limit activity of each user with each content item in the user-content interaction data set. For example, the server 120 may remove indications that a specific user interacted with a specific content item more than a predetermined threshold number of times.

At step 550, the server 120 computes statistics, using the preprocessed user-content interaction data set, to respond to the request for statistics. The computed statistics are regarding interactions of users having a specified user feature with content items having a specified content feature.

At step 560, the server 120 generates output statistics by adding a random noise variable to the computed statistics. The random noise variable is used to anonymize the output statistics to ensure differential privacy and to prevent the recipient of the output statistics from identifying individual users whose data was used to generate the output statistics.

At step 570, the server 120 provides a representation of the generated output statistics, for example, to the client device 110 requesting the output statistics. The output statistics may be provided in the format specified in the request. After step 570, the method 500 ends.

Aspects of the subject technology are described as being implemented in conjunction with a social networking service. However, the subject technology is not limited to the social networking context. The subject technology may be implemented in any service where users interact with content items, not necessarily a social networking service. For example, the subject technology may be implemented in conjunction with an online video service, an online newspaper, an online shopping service, an electronic book store, etc.

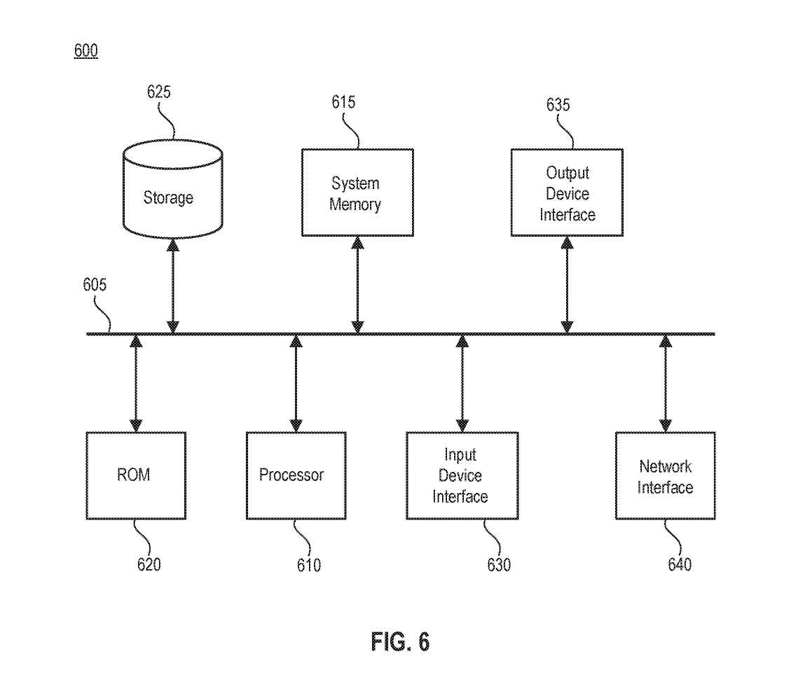

FIG. 6 conceptually illustrates an electronic system 600 with which some implementations of the subject technology are implemented. For example, one or more of the client device 110, the server 120, or the data repository 130 may be implemented using the arrangement of the electronic system 600. The electronic system 600 can be a computer (e.g., a mobile phone, PDA), or any other sort of electronic device. Such an electronic system includes various types of computer-readable media and interfaces for various other types of computer-readable media. Electronic system 600 includes a bus 605, processor(s) 610, a system memory 615, a read-only memory (ROM) 620, a permanent storage device 625, an input device interface 630, an output device interface 635, and a network interface 640.

The bus 605 collectively represents all system, peripheral, and chipset buses that comtnunicatively connect the numerous internal devices of the electronic system 600. For instance, the bus 605 communicatively connects the processor(s) 610 with the read-only memory 620, the system memory 615, and the permanent storage device 625.

From these various memory units, the processor(s) 610 retrieves instructions to execute and data to process in order to execute the processes of the subject technology. The processor(s) can include a single processor or a multi-core processor in different implementations.

The read-only-memory (ROM) 620 stores static data and instructions that are needed by the processor(s) 610 and other modules of the electronic system. The permanent storage device 625, on the other hand, is a read-and-write memory device. This device 625 is a non-volatile memory unit that stores instructions and data even when the electronic system 600 is off. Some implementations of the subject technology use a mass-storage device (for example a magnetic or optical disk and its corresponding disk drive) as the permanent storage device 625. Other implementations use a removable storage device (for example a floppy disk, flash drive, and its corresponding disk chive) as the permanent storage device 625,

Like the permanent storage device 625, the system memory 615 is a read-and-write memory device. However, unlike storage device 625, the system memory 615 is a volatile read-and-write memory, such as a random access memory. The system memory 615 stores some of the instructions and data that the processor 610 needs at runtime. In some implementations, the processes of the subject technology are stored in the system memory 615, the permanent storage device 625, or the read-only memory 620. For example, the various memory units include instructions for releasing content interaction statistics while preserving privacy in accordance with some implementations. From these various memory units, the processor(s) 610 retrieves instructions to execute and data to process in order to execute the processes of some implementations.

The bus 605 also connects to the input and output device interfaces 630 and 635. The input device interface 630 enables the user to communicate information and select commands to the electronic system 600. Input devices used with input device interface 630 include, for example, alphanumeric keyboards and pointing devices (also called “cursor control devices”). Output device interfaces 635 enable, for example, the display of images generated by the electronic system 600. Output devices used with output device interface 635 include, for example, printers and display devices, for example cathode ray tubes (CRT) or liquid crystal displays (LCD). Some implementations include devices, for example a touch screen, that function as both input and output devices,

Finally, as shown in FIG. 6, bus 605 also couples electronic system 600 to a network (not shown) through a network interface 640. In this manner, the electronic system 600 can be a part of a network of computers (for example a local area network (LAN), a wide area network (WAN), or an Intranet, or a network of networks, for example the Internet. Any or all components of electronic system 600 can be used in conjunction with the subject technology.

The above-described features and applications can be implemented as software processes that are specified as a set of instructions recorded on a computer-readable storage medium (also referred to as computer-readable medium). When these instructions are executed by one or more processor(s) (which may include, for example, one or more processors, cores of processors, or other processing units), they cause the processor(s) to perform the actions indicated in the instructions. Examples of computer-readable media include, but are not limited to, CD-ROMs, flash drives, RAM chips, hard drives, erasable programmable read-only memory (EPROM), etc. The computer-readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra-density optical discs, any other optical or magnetic media, and floppy disks. The computer-readable media can store a computer program that is executable by at least one processor and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a cathode ray tube (CRT) or liquid crystal display (LCD) monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or, in some cases, one or more of the illustrated steps may be omitted. Some of the steps may be performed simultaneously. For example, in certain circumstances, multitasking and parallel processing may be implemented. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, “an aspect,” does not imply that the aspect is essential to the subject technology or that the aspect applies to all configurations of the subject technology. A disclosure relating to an aspect may apply to all configurations, or one or more configurations. A phrase, for example, “an aspect,” may refer to one or more aspects and vice versa. A phrase, for example, “a configuration,” does not imply that such configuration is essential to the subject technology or that such configuration applies to all configurations of the subject technology. A disclosure relating to a configuration may apply to all configurations, or one or more configurations. A phrase, for example, “a configuration,” may refer to one or more configurations and vice versa.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the disclosed subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

In this document, the terms “a” or “an” are used, as is common in patent documents, to include one or more than one, independent of any other instances or usages of “at least one” or “one or more.” In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels, and are not intended to impose numerical requirements on their objects.

What is claimed is:

1. A method comprising:
receiving, at a server, a request for statistics about user interaction with content items, wherein users are grouped according to user features, and wherein the content items are grouped according to content features;
accessing, in response to the request for statistics, a user-content interaction log, the user-content interaction log storing data representing interactions of a plurality of users with a plurality of content items;
generating, using the user-content interaction log, a user-content interaction data set grouping users according to the user features and grouping content items according to the content features specified in the request for statistics;
preprocessing the user-content interaction data set to limit activity of each user with each content item in the user-content interaction data set;
computing statistics, using the preprocessed user-content interaction data set, regarding interactions of users having a specified user feature with content items having a specified content feature;
generating output statistics by adding a random noise variable to the computed statistics; and
providing a representation of the generated output statistics.

2. The method of claim 1, further comprising:
post-processing the generated output statistics to ensure consistency with the user-content interaction data set.

3. The method of claim 1, wherein the users include users of a social networking service and wherein the content items include job postings within the social networking service.

4. The method of claim 3, wherein:
the user features include one or more of: an industry of a user, a profession of the user, a professional level of seniority of the user, an academic degree of the user, an educational institution of the user, and a geographic location of the user; and
the content features include one or more of: an industry of a job, a profession associated with the job, a professional level of seniority associated with the job, a proposed salary for the job, and a geographic location of the job.

5. The method of claim 3, wherein interactions of users with content items, stored in the user-content interaction log, include one or more of: viewing a job posting within a listing of job postings, selecting the job posting from within the listing of job postings, applying for the job posting, and indicating acceptance of a position associated with the job posting.

6. The method of claim 1, wherein the computed statistics include a proportion of users having specified user features who interacted with one or more content items having specified content item features according to specified interactions.

7. The method of claim 1, wherein, after preprocessing the user-content interaction data set to limit activity of each user with each content item in the user-content interaction data set, each and every user whose data is in the preprocessed user-content interaction data set cannot be identified using information from the preprocessed user-content interaction data set.

8. The method of claim 1, wherein providing a representation of the generated output statistics comprises:
transmitting, to a client device associated with the received request for statistics, the representation of the generated output statistics using a format specified in the received request for statistics.

9. A non-transitory machine-readable medium comprising instructions which, when executed by one or more processors of a machine, cause the machine to perform operations comprising:
receiving a request for statistics about user interaction with content items, wherein users are grouped according to user features, and wherein the content items are grouped according to content features;
accessing, in response to the request for statistics, a user-content interaction log, the user-content interaction log storing data representing interactions of a plurality of users with a plurality of content items;
generating, using the user-content interaction log, a user-content interaction data set grouping users according to the user features and grouping content items according to the content features specified in the request for statistics;
preprocessing the user-content interaction data set to limit activity of each user with each content item in the user-content interaction data set;
computing statistics, using the preprocessed user-content interaction data set, regarding interactions of users having a specified user feature with content items having a specified content feature;
generating output statistics by adding a random noise variable to the computed statistics; and
providing a representation of the generated output statistics.

10. The machine-readable medium of claim 9, the operations further comprising:
post-processing the generated output statistics to ensure consistency with the user-content interaction data set.

11. The machine-readable medium of claim 9, wherein the users include users of a social networking service and wherein the content items include job postings within the social networking service.

12. The machine-readable medium of claim 11, wherein:
the user features include one or more of: an industry of a user, a profession of the user, a professional level of seniority of the user, an academic degree of the user, an educational institution of the user, and a geographic location of the user; and
the content features include one or more of: an industry of a job, a profession associated with the job, a professional level of seniority associated with the job, a proposed salary for the job, and a geographic location of the job.

13. The machine-readable medium of claim 9, wherein interactions of users with content items, stored in the user-content interaction log, include one or more of:
viewing a job posting within a listing of job postings, selecting the job posting from within the listing of job postings, applying for the job posting, and indicating acceptance of a position associated with the job posting.

14. The machine-readable medium of claim 9, wherein the computed statistics include a proportion of users having specified user features who interacted with one or more content items having specified content item features according to specified interactions.

15. The machine-readable medium of claim 9, herein, after preprocessing the user-content interaction data set to limit activity of each user with each content item in the user-content interaction data set, each and every user whose data is in the preprocessed user-content interaction data set cannot be identified using information from the preprocessed user-content interaction data set.

16. The machine-readable medium of claim 9, wherein providing a representation of the generated output statistics comprises:
transmitting, to a client device associated with the received request for statistics, the representation of the generated output statistics using a format specified in the received request for statistics.

17. A system comprising:
one or more processors; and
a memory comprising instructions which, when executed by the one or more processors, cause the one or more processors to perform operations comprising:
receiving a request for statistics about user interaction with content items, wherein users are grouped according to user features, and wherein the content items are grouped according to content features;
accessing, in response to the request for statistics, a user-content interaction log, the user-content interaction log storing data representing interactions of a plurality of users with a plurality of content items;
generating, using the user-content interaction log, a user-content interaction data set grouping users according to the user features and grouping content items according to the content features specified in the request for statistics;
preprocessing the user-content interaction data set to limit activity of each user with each content item in the user-content interaction data set;
computing statistics, using the preprocessed user-content interaction data set, regarding interactions of users having a specified user feature with content items having a specified content feature;
generating output statistics by adding a random noise variable to the computed statistics; and
providing a representation of the generated output statistics.

18. The system of claim 17, the operations further comprising:
post-processing the generated output statistics to ensure consistency with the user-content interaction data set.

19. The system of claim 17, wherein the users include users of a social networking service and wherein the content items include job postings within the social networking service.

20. The system of claim 19, wherein:
the user features include one or more of: an industry of a user, a profession of the user, a professional level of seniority of the user, an academic degree of the user, an educational institution of the user, and a geographic location of the user; and
the content features include one or more of: an industry of a job, a profession associated with the job, a professional level of seniority associated with the job, a proposed salary for the job, and a geographic location of the job.
